(19) United States
(12) Patent Application Publication
(10) Pub. No.: US 2018/0191013 A1
(43) Pub. Date: Jul. 5, 2018

(54) Enhancement of Conductivity in Nanostructured Proton Exchange Membranes

(71) Applicant: The Board of Trustees of the Leland Stanford Junior University, Palo Alto, CA (US)

(72) Inventors: Curtis W. Frank, Cupertino, CA (US); Euntaek Woo, Seoul (KR); Jie Lu, Los Altos, CA (US); Michael F. Toney, Menlo Park, CA (US)

(21) Appl. No.: 15/789,062

(22) Filed: Oct. 20, 2017

Related U.S. Application Data
(60) Provisional application No. 62/410,489, filed on Oct. 20, 2016.

(51) Int. Cl. H01M 8/1027; C08G 73/10; C08J 5/22; B01J 39/19; H01M 8/103

(52) U.S. Cl. CPC H01M 8/1027; C08G 73/1071; C08J 5/2268; H01M 2008/1095; H01M 8/103; C08J 2379/08; B01J 39/19

(57) ABSTRACT

An ion exchange membrane is provided with a nanostructure material of random poly(ethylene glycol)-polyimide copolymers doped and annealed in an ionic liquid, the poly(ethylene glycol) having a molecular weight ranging from 1000 to 4000 and the poly(ethylene glycol) representing at least 40% of the volume of the ion exchange membrane. It is shown that the conductivity of these membranes was dramatically increased by the thermal annealing by 2-5 times. It was also shown that nanoscale structures were developed upon heating the membranes involving the increment of order, definition, and size of the poly(ethylene glycol)-ethylammonium nitrate [PEG+EAN] domains by the SAXS data analysis. This structural change improves the ion conduction in the membrane and result in the considerable enhancement of the conductivity.

### CROSS-REFERENCE TO RELATED APPLICATIONS

This application claims priority from U.S. Provisional Patent Application 62/410,489 filed Oct. 20, 2016, which is incorporated herein by reference.

### STATEMENT OF GOVERNMENT SPONSORED SUPPORT

This invention was made with Government support under contract 1511373 awarded by the National Science Foundation. The Government has certain rights in the invention.

### FIELD OF THE INVENTION

This invention relates to polymer electrolyte membrane fuel cells.

### BACKGROUND OF THE INVENTION

The class of ion-conducting polymers are of great interest for their various applications including fuel cell membranes, battery electrolytes, supercapacitors, actuators, and gas separation membranes. Polymer electrolyte membranes (PEM) for fuel cells (FC) have been extensively studied because they play a key role in the PEMFC, which is a promising clean energy source for the automotive industry in the near future. However, there are still technological challenges to solve the issues of current PEMFCs. In particular, PEMFCs are limited to low operating temperatures below 90° C. in high humidity environments owing to the significant decrease of the transport properties of current PEMs under water-deficient environments. The present invention advances the art by addressing the conductivity of nanostructured proton exchange membranes.

### SUMMARY OF THE INVENTION

The present invention provides in one embodiment proton exchange membranes which have been fabricated from random multi-block copolymers of an aromatic dianhydride reacted with mixtures of two different diamines. One of these diamines has an aromatic core, which may be fluorinated, and the other diamine is based on poly(ethylene oxide) of variable molecular weight. The copolymer is synthesized by a two-step process—a polyamic acid is first formed by the reaction of the two anhydride groups of the aromatic dianhydride with the mixture of diamines; the second step is a thermal ring closure to form aromatic polyimides. After doping with an ionic liquid, such as ethyl ammonium nitrate, these materials exhibit proton conductivities in the range of 50 mS/cm. The invention provided herein is that we have discovered that a brief thermal annealing of these doped membranes at temperatures ranging up to 160 degrees Celsius leads to the increase of conductivity to the range of 200 mS/cm or even beyond to about 400 mS/cm. These higher values are significantly better than the industry standard Nafion membrane.

The polyimide-poly(ethylene oxide) random multi-block copolymer can be synthesized in an extremely large range of variations. Many fluorinated and unfluorinated aromatic di-anhydrides, fluorinated and unfluorinated aromatic diamines and poly(ethylene oxide) diamines of molecular weights ranging from 1000 to 4000 may be combined and optimized. Furthermore, the nature of the ionic liquid can be varied over a wide range including the methyl ammonium nitrate, ethyl ammonium nitrate, propyl ammonium nitrate and other examples. Finally, the thermal annealing protocol that is responsible for the dramatic increase in conductivity can be varied in terms of temperature range, rates of heating and duration of annealing.

The Nafion membrane is a fluorinated polymer containing short grafted chains of fluorinated propylene oxides that are terminally sulfonated. It is limited to operating temperatures less than 80 degrees Celsius, because it needs to remain hydrated in order to function as a proton transport material. The material disclosed herein should be capable of operating at higher temperatures with significantly higher conductivity than Nafion.

The present invention provides in another embodiment an ion exchange membrane with a nanostructure material of random poly(ethylene glycol)-polyimide copolymers doped and annealed in an ionic liquid, the poly(ethylene glycol) having a molecular weight ranging from 1000 to 4000 and the poly(ethylene glycol) representing at least 40% of the volume of the ion exchange membrane.

The lower limit of the molecular weight is set by the domain size and the ability to swell with the ionic liquid. The upper limit is set by the mechanical properties of the nanostructure material. It is desired that the poly(ethylene glycol) remains amorphous for it to absorb the ionic liquid, but higher molecular weights could lead to the PEG becoming crystalline, which would hamper the ionic liquid uptake. Based on the current understanding of the invention, the preferred poly(ethylene glycol) molecular weight is between 1000 and 2500, more specifically about 1500.

### BRIEF DESCRIPTION OF THE DRAWINGS

FIGS. 1A-E show according to an exemplary embodiment of the invention chemical structures of monomers and ionic liquid: (FIG. 1A) 6FDA, (FIG. 1B) PDODA, (FIG. 1C) PEG1500, (FIG. 1D) ethylammonium nitrate (EAN), and a schematic diagram of a single copolymer chain (FIG. 1E).

FIG. 2 shows according to an exemplary embodiment of the invention a schematic diagram of the sample assembly for thermal annealing.

FIG. 3 shows according to an exemplary embodiment of the invention EAN uptake and the conductivity of PEG-PI membranes as a function of the PEG content.

FIG. 4 shows according to an exemplary embodiment of the invention SAXS profiles of PEG-PI copolymer membranes as a function of PEG content. Undoped membranes (left) showed no or very small shoulders. EAN-doped membranes showed broad peaks at a certain PEG content.

FIG. 5 shows according to an exemplary embodiment of the invention TGA thermograms of three representative PEG-PI membranes.

FIG. 6 shows according to an exemplary embodiment of the invention SAXS profiles of 46.8 wt % PEG-PI copolymer membrane as a function of temperature. Undoped membranes (left) showed no change with temperature. On the other hand, the EAN-doped membrane showed a distinctive peak development with temperature. The peak intensity increased and the position shifted to lower q as the temperature was increased. (see Supporting Information for the full set of SAXS data, infra).

FIG. 7 shows according to an exemplary embodiment of the invention pair correlation functions γ(r) of 46.8 wt % PEG-PI copolymer membrane calculated using the Teubner-Strey model. Data near the d-spacing are enlarged in the inset.

FIG. 8 shows according to an exemplary embodiment of the invention d-spacing and correlation length, ξ for the membranes with PEG contents of 33.6, 42.1, and 46.8 wt % depending on the temperature.

FIG. 9 shows according to an exemplary embodiment of the invention Conductivity of the EAN-doped PEG-PI membranes depending on the annealing temperature. (Conductivity was measured at 60 degrees Celsius, 70% RH).

FIG. 10 shows according to an exemplary embodiment of the invention the conductivity of the EAN-doped PEG-PI membranes depending on the annealing time at 100° C. (Conductivity was measured at 60 degrees Celsius, 70% RH).

FIG. 11 shows according to an exemplary embodiment of the invention FTIR spectra of PEG 46.8 wt % poly(amic acid) and polyimide.

FIG. 12 shows according to an exemplary embodiment of the invention DSC thermograms of PEG-PI membranes with various PEG content.

FIGS. 13A-F show according to an exemplary embodiment of the invention SAXS profiles of PEG-PI copolymer membrane with different PEG contents.

FIG. 14 shows according to an exemplary embodiment of the invention SAXS profiles of PEG-PI copolymer membrane with 46.8 wt % and fitted functions using the Teubner-Strey model.

FIGS. 15A-B show according to an exemplary embodiment of the invention pictures of (FIG. 15A) the conductivity clamp with a PEG-PI membrane and (FIG. 15B) the conductivity cell used in this invention.

FIG. 16 shows according to an exemplary embodiment of the invention tensile modulus of undoped PEG-PI membranes.

FIG. 17 shows according to an exemplary embodiment of the invention how a “shoulder” in a SAXS spectrum undergoes a transition to a “peak” as the structural order increases. It is noted that this kind of behavior is what the inventors' have discovered upon annealing of their nano-structured PEG-polyimide multi block polymer. The plots represent model scattering curves for uniform spheres, variable degree of order. Stronger peak means stronger correlation. Curve 1710 has the same degree of correlation as the curve 1720 but twice the minimum distance between spheres.

FIG. 18 shows according to an exemplary embodiment of the invention the proton exchange membrane fuel cell.

FIG. 19 shows according to an exemplary embodiment of the invention the polymer synthesis.

FIG. 20 shows according to an exemplary embodiment of the invention Fourier transfer infrared spectroscopy results.

FIG. 21 shows according to an exemplary embodiment of the invention thermal gravimetric analysis results.

FIG. 22 shows according to an exemplary embodiment of the invention differential scanning calorimetry results.

FIGS. 23-24 show according to an exemplary embodiment of the invention tensile test results.

FIG. 25 shows according to an exemplary embodiment of the invention microstructure characterization results.

FIG. 26 shows according to an exemplary embodiment of the invention intensity plots.

FIGS. 27-29 show according to an exemplary embodiment of the invention ionic liquid doping results.

FIG. 30 shows according to an exemplary embodiment of the invention conductivities of EAN doped membranes.

FIG. 31 shows according to an exemplary embodiment of the invention small angle X-ray scattering plots.

FIG. 32 shows according to an exemplary embodiment of the invention conductivities of EAN doped membranes after thermal treatment.

### DETAILED DESCRIPTION

In this invention, copolymers of aromatic polyimide (PI) and poly(ethylene glycol) (PEG) incorporated with ionic liquids (IL) is provided as a new family of PEMs. In these copolymer systems, PEG domains act as the ion conducting phase and the PI phase serves as a supporting matrix. There are several advantages of these PEG-PI/IL membranes as compared to current PEMs. They can be easily manufactured and processed using high-yield chemistry, making them readily accessible. Physical properties including ion transport and thermal/mechanical properties can be controlled in a wide range by varying the composition. They also could be operated at higher temperatures or lower humidity conditions than some of the other leading PEMs. Additionally, they might be manufactured with a lower cost than the current PEMs.

In this invention, we investigated the nanoscale structural development and corresponding enhancement of the conductivity of PEG-PI copolymer membranes imbibed with an ionic liquid. A specific PEG-PI copolymer was studied because it showed the best performance among several monomer combinations in our work on the impact of the monomer structures, PEG contents, and PEG molecular weight on performance. Also ethylammonium nitrate (EAN) was used as a representative ionic liquid because the EAN-doped PEG-PI membranes showed the highest conductivity among several ionic liquids including propylammonium nitrate (PAN), methylammonium nitrate (MAN), and dimethylammonium nitrate (DMAN).

### Method

### Materials

4,4′-(hexafluoroisopropylidene) diphthalic anhydride (6FDA), 4,4′-(1,3-phenylenedioxy)dianiline (PDODA), bis(3-aminopropyl) terminated poly(ethylene glycol) (PEG1500, Mn˜1,500), and N,N-dimethylacetamide (DMAc) were purchased from Sigma Aldrich and used as received. Ethylammonium nitrate (EAN) was purchased from Iolitec and used as received. The PEG content of the membrane used in this invention represents the weight fraction of PEG1500 in the total weight of reactants.

### Synthesis

First, the bis(amine) terminated PEG and the aromatic diamine, PDODA, were placed into a three-neck flask. Then, the solvent, DMAc, was placed into the flask. The contents were allowed to stir under nitrogen and gently heated to approximately 60 degrees Celsius until all the solids were dissolved. The flask was then cooled to room temperature and a stoichiometric amount of solid aromatic dianhydride, 6FDA, was slowly added to the flask over a period of 30 min. Total solids concentration was controlled between 0.075 and 0.09 g/mL. The contents of the flask were stirred at room temperature in nitrogen atmosphere for 24 h and were then collected for future use as the PEG-containing poly(amic acid) precursor.

### Casting/Imidization

The poly(amic acid) precursor solutions were poured into a Teflon dish and thermally imidized in an oven using the following heating protocol: ramp from 20° C. to 90° C. over a period of 2 h and 15 min, then ramp to 130 degrees Celsius over a period of 3 h, hold at 130 degrees Celsius for 11 h, ramp to 155 degrees Celsius over a period of 3 h, hold at 155 degrees Celsius for 1 h, cool to 25 degrees Celsius over a period of 4 h. The dry, free standing films were then collected for future testing. The thicknesses of the membranes after imidization were controlled to be in the range from 100 to 300 μm.

### Ionic Liquid Incorporation

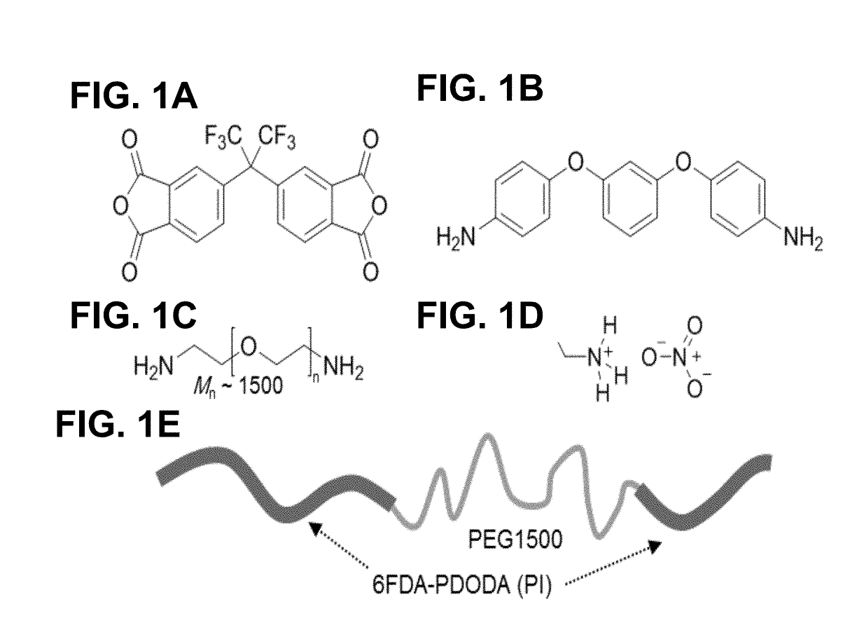

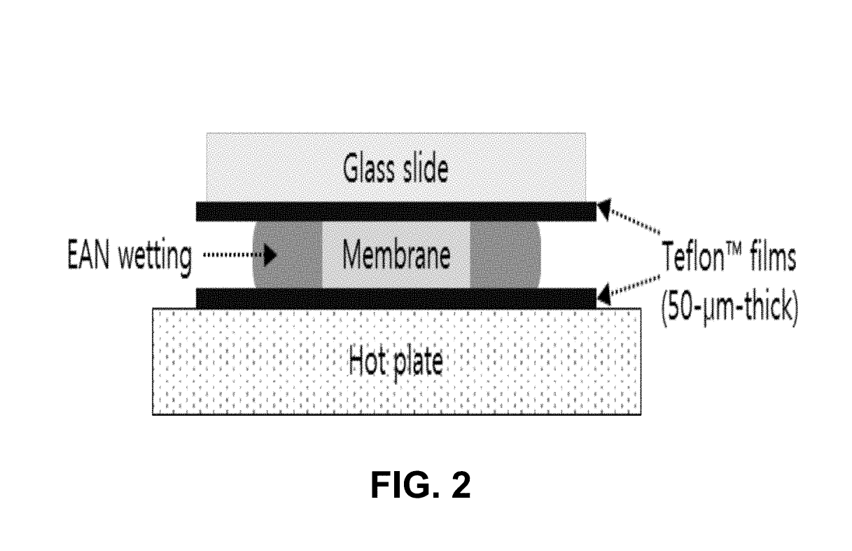

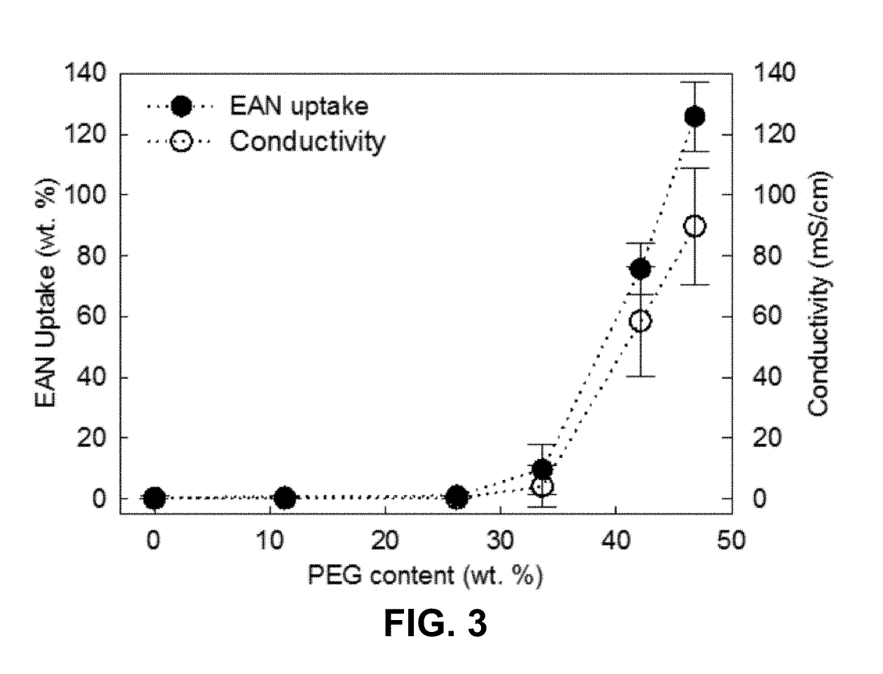

The imidized freestanding films were cut into appropriate sizes, placed into ethylammonium nitrate in a capped container at room temperature for at least 5 days, and then were removed and tested as needed. FIG. 1 shows chemical structures of the monomers, the ionic liquid, and a schematic diagram of a final PEG-PI copolymer chain.

### Thermal Annealing

The membranes were sandwiched between two 50-μm-thick Teflon films with a few drops of wetting EAN. The assembly was then placed on a pre-heated digital hot plate and a pre-heated glass slide was put on top of it. The membranes were annealed for 10 minutes unless otherwise specified. The temperature of the membrane was verified using a Fluke 51 digital thermometer with a thin (Omega K type) thermocouple, which was found to be lower than the temperature displayed on the hot plate by ˜3 degrees Celsius over the temperature range of 100-140 degrees Celsius. The annealing temperatures hereafter refer to the displayed temperature value on the hot plate itself. This protocol helps prevent air contact, evaporation of EAN, and film deformation during thermal annealing.

### Characterization

Fourier transform infrared spectroscopy (FTIR) measurements were performed at room temperature using a Nicolet iS50 FT/IR Spectrometer in attenuated total reflection (ATR) mode. Sample preparation involved drop casting a small amount of the poly(amic acid) precursor solution onto a glass slide and subsequent imidizing as described above or removing the solvent by gently heating the sample at 40 degrees Celsius on a hot plate for 24 hrs. FTIR was used to qualitatively confirm the success of the polymer synthesis and imidization.

Thermal gravimetric analysis (TGA) was performed using a TA Instrument Q500. Film samples between 5 and 15 mg were loaded into platinum pans and then heated from 25 degrees Celsius to 750 degrees Celsius at a rate of 15 degrees Celsius per minute.

Ionic liquid uptake measurements were performed as follows: The undoped polymer was first weighed, then soaked in EAN for 5 days at room temperature. The EAN-doped polymer was then dabbed dry and reweighed to determine EAN uptake. The values for the ionic liquid uptake are based on an average of three measurements for different membranes.

Conductivity measurements were performed using a BT 552 Bekktech conductivity analyzer and a Gamry Instruments Reference 600 Potentiostat/Galvanostat via electrochemical impedance spectroscopy (EIS). The AC impedance measurement was performed with an amplitude of 10 mV over a frequency range of 200,000-0.1 Hz. Measurements were performed under nitrogen at 70% relative humidity (RH) at 60 degrees Celsius, unless otherwise noted. The samples were kept at the measuring temperature and humidity at least 30 min. before the measurement to improve probe-to-film contact and equilibrate the equipment to the humidity levels. Membrane conductivity was calculated using the resistivity at the high frequency limit from the Nyquist plot and the sample dimensions. The conductivity values represent an average over three different films tested on different days. The individual film measurement values were based on an average of 5 measurements per single temperature on the same film. Ion Power Nafion N115 membrane was used for comparison.

Small angle x-ray scattering (SAXS) was performed at beam line 1-5 at SLAC Synchrotron Radiation Laboratory (Stanford, Calif.). The wave length of the x-ray beam was 1.378 Angstrom and the sample-to-detector distance was ˜1 meter. Detector calibration was done using a silver behenate standard. The 2D raw data were averaged and reduced to 1D data using Igor Nika software/macro package. All data are corrected based on the measurement of the background scattering with an exposure time of 3 min. For temperature-resolved SAXS experiments, the samples were equilibrated at designated temperatures for 10-30 min before the measurement.

### Results

The success of the synthesis of poly(amic acid) precursor and the completion of the thermal imidization were confirmed using FTIR (see Supporting Information infra for FTIR spectra).

### Properties Before Annealing

The EAN uptake was calculated in weight percent as follows:

$$EAN uptake ( \% ) = \frac{{W}_{e} - {W}_{d}}{{W}_{d}} \times 100 \qquad ( 1 )$$

where W_{d} and Wₑ are the weights of dry and corresponding EAN-doped membranes, respectively.

EAN uptake started to increase with increasing PEG content from a particular PEG wt % between 26.2 and 33.6. The conductivity also increased with increasing PEG content such that the trends of the two data sets were almost exactly the same. It seems that there is a percolation threshold between 26.2 and 33.6 wt %, which corresponds to 31.0 and 39.0 vol %, respectively. This range of volume fraction is very similar to the percolation threshold of a simple cubic lattice, 31.2 vol %, which was theoretically derived from discrete percolation theory. It is unlikely that the PEG-PI copolymers form a perfect cubic lattice of spherical clusters. However, it is reasonable to think that there are sphere-like phase separated domains of PEG and/or [PEG+EAN], and they start to connect with each other at a PEG content between 26.2 and 33.6 wt % and form ion conducting channels as the PEG content is increased further. This structural change may result in the sudden increase of the conductivity.

The conductivity of Nafion is known to range from 50 to 230 mS/cm depending on the pre-treatment conditions and measuring method. The average conductivity of N115 membrane that we measured after equilibration in EAN and in 20 vol % phosphoric acid solution was 23.8 and 39.5 mS/cm, respectively. (at 60° C., 70% RH). This means that the EAN-doped PEG-PI membranes have conductivity comparable to that of Nafion 115 without any further treatment or modification such as annealing described below, or incorporating inorganic materials.

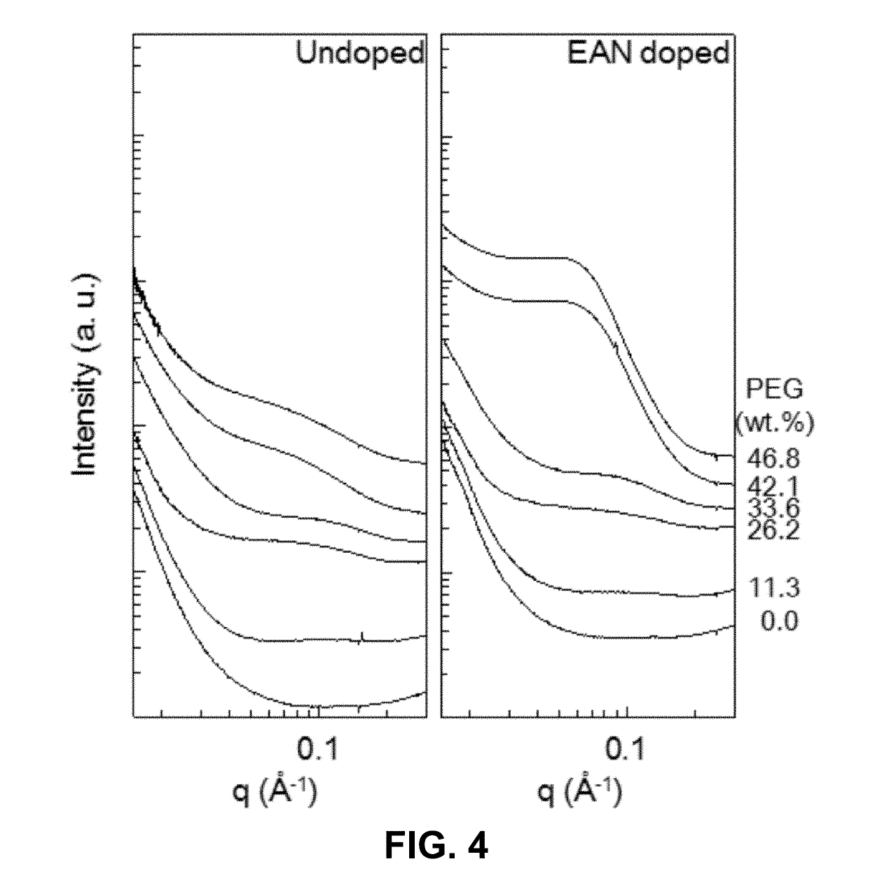

FIG. 4 shows SAXS profiles of undoped and EAN-doped PEG-PI copolymer membranes as a function of PEG content. No distinguishable peak was observed for undoped membranes. We could see only broad shoulders around q 0.05-0.2 A⁻¹ which can be contributed to weakly correlated PEG-domains. When the EAN is doped in the membranes with PEG contents higher than 26.2 wt %, those shoulders increased in clarity and prominence with increasing PEG content eventually forming a broad peak.

The EAN-doped PEG-PI membranes can be considered as having two major phases. One is the PEG incorporated with EAN [PEG+EAN] phase and the other one is 6FDA-PDODA PI phase. According to the solubility tests of the polymers used in this study in EAN, 6FDA-PDODA PI was insoluble in EAN at least up to the highest temperature we tested, 140 degrees Celsius. On the contrary, EAN was a good solvent of PEG1500 even at room temperature as long as the PEG crystallites were dissolved at a temperature above their melting temperature around 50 degrees Celsius. Therefore, the EAN expected to interact selectively with PEG domains in our PEG-PI membranes. Additionally, there was no evidence of crystalline PEG phase in the DSC measurements (see Supporting Information infra for DSC data. The spatial confinement of rigid PI chains may frustrate the crystallization of PEG.

The formation of peaks in the SAXS patterns means there is an increase of the order and definition of the [PEG+EAN] domains as the membranes were soaked with EAN. The formation of peaks could be hardly attributed to an X-ray scattering contrast issue because the estimated X-ray scattering length density of EAN was in between those of PEG and PI. Therefore, the peak is expected to diminish as the EAN is incorporated with PEG if we only consider the scattering contrast. The calculated X-ray scattering length density based on their chemical structures and known bulk densities using Igor Nika software package were as follows: 12.2×10¹⁰ cm⁻² for 6FDA-PDODA PI, 10.3×10¹⁰ cm⁻² for PEG, and 11.4×10¹⁰ cm⁻² for EAN.

The larger the EAN uptake becomes, the stronger the peak seems to appear. This newly formed structural feature is thought to be related to the increase of conductivity. The order and positional boundary definition of phases as well as the amount of EAN in the membrane is expected to impact transport properties based on trends seen previously for polyimides and other polymer electrolyte systems.

### Thermal Stability

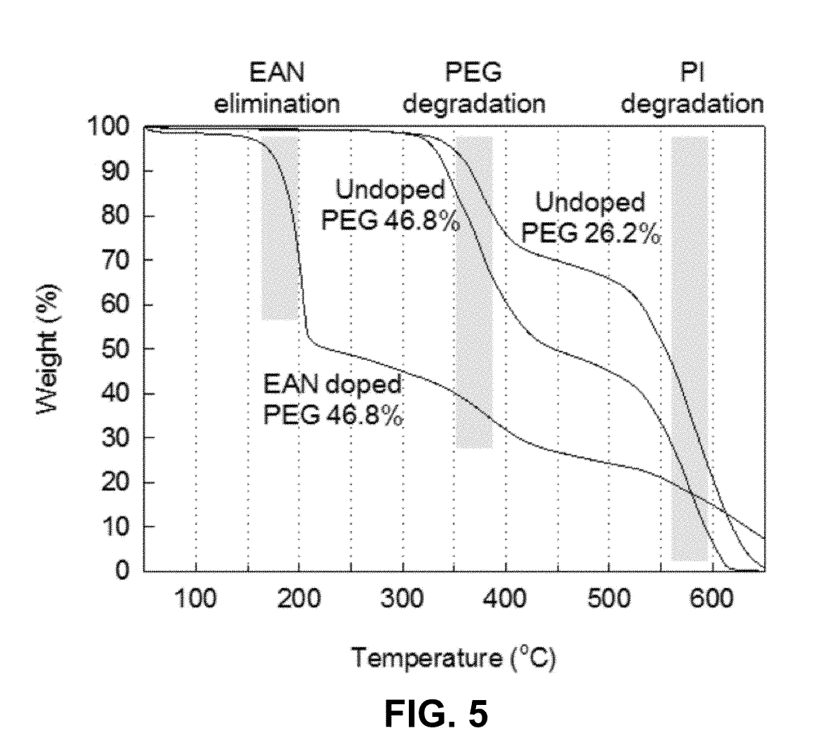

All TGA experiments were performed under air atmosphere since the membranes are likely to be exposed to oxygen or air in their application. Three different temperature ranges of weight loss were observed as marked in FIG. 5. The first weight loss just below 200 degrees Celsius is the EAN elimination because it was observed only for the EAN-doped membranes and it occurred near the boiling point of EAN (˜240 degrees Celsius). In addition, the amount of weight loss was similar to the amount of uptaken EAN. The second weight loss around 370 degrees Celsius can be regarded as the degradation of PEG because the weight loss in this region corresponded very well with the PEG contents of the membranes. Finally, the PI degradation was observed at the highest temperature region above 500 degrees Celsius. In other words, the undoped membranes were stable up to ˜300 degrees Celsius, whereas EAN-doped membranes can be used up to ˜140 degrees Celsius due to the relatively low boiling point of EAN. However, 140 degrees Celsius is still considerably higher than the usual operating temperature of Nafion-based fuel cells (˜80 degrees Celsius).

### Structural Development Upon Heating

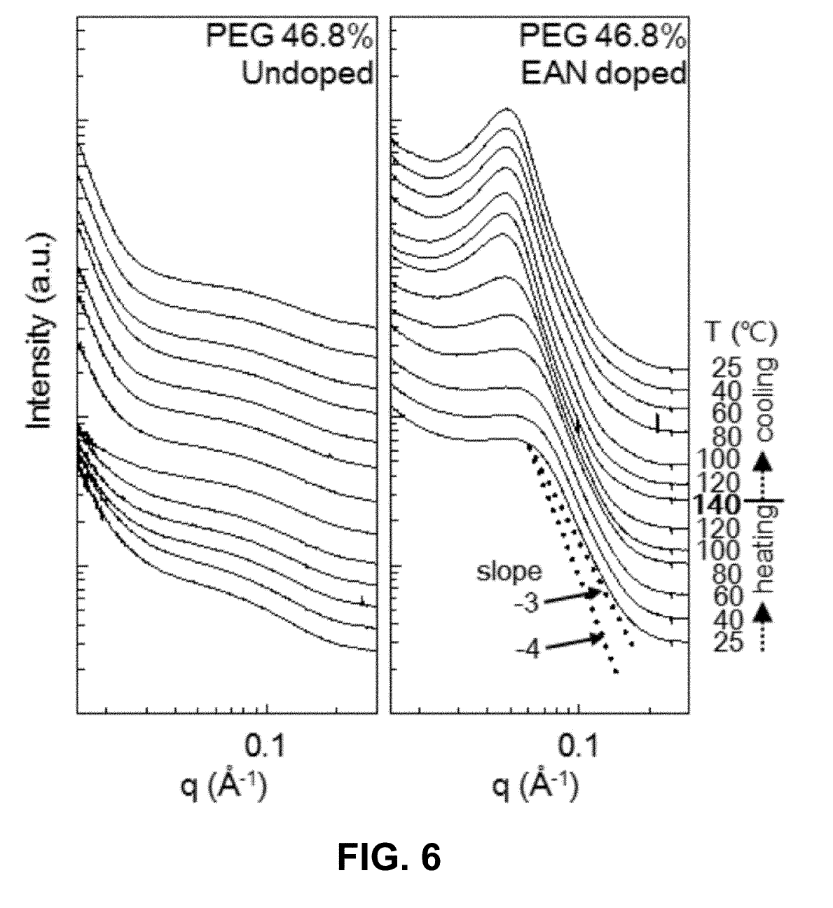

SAXS profiles of 46.8 wt % PEG-PI copolymer membrane as a function of temperature are shown in FIG. 6. Undoped membranes showed no change depending on the temperature, while the EAN-doped membrane showed a distinctive peak as described supra. The peak intensity was increased and also the position was shifted to lower q when the temperature increased. The peak position and intensity never returned to its original value even after cooling down to room temperature. This phenomenological trend was also clearly observed in the SAXS data of 42.1 and 33.6 wt % PEG-PI copolymer membranes. (see Supporting Information infra for full sets of SAXS data).

The structural development upon heating can be understood more through SAXS data analysis using Teubner-Strey (TS) model and Porod exponent analysis. The Teubner-Strey (TS) model showed the best fit to the SAXS data of PEG-PI membranes among several theoretical or empirical models describing the SAXS intensity including the Guinier-Porod model, the correlation length model, and the broad peak model. The TS model was originally introduced to describe the structure of two-component micellar systems and often accurately describes scattering from bicontinuous structures. The PEG-PI membranes can be viewed as having two phases of [PEG+EAN] and PI as described previously and eventually forming a pseudo-bicontinuous phase. In the TS model, the pair correlation function γ(r) in real space was assumed to have the form:

$$γ ( r ) = \frac{d}{2 π r} exp ( - \frac{r}{ξ} ) sin ( \frac{2 π r}{d} ) \qquad ( 2 )$$

where d is a quasi-periodic repeat distance and ξ is a correlation length. Physical meaning of d and ξ can readily be understood from this equation. d and ξ are the characteristic lengths of the periodicity and the exponential decay of γ(r), respectively.

Then, the scattered intensity, I(q) can be expressed as follows:

$$I ( q ) = TS \frac{1}{a + {c}_{1} {q}^{2} + {c}_{2} {q}^{4}} + B \qquad ( 3 )$$

where TS and B are the constants related to the scattering contrast and the background scattering, respectively. The parameters a, c₁, and c₂ are related to the two characteristic lengths, d and ξ, as indicated below:

$$\begin{matrix}ξ = {[ \frac{1}{2} {( \frac{a}{{c}_{2}} )}^{1 / 2} + \frac{1}{4 {c}_{2}} ]}^{- 1 / 2} & ( 4 ) \\ d = 2 {π [ \frac{1}{2} {( \frac{a}{{c}_{2}} )}^{1 / 2} + \frac{1}{4 {c}_{2}} ]}^{- 1 / 2} & ( 5 )\end{matrix}$$

The SAXS data were fitted using equation (3) with five fitting parameters of TS, a, c₁, c₂, and B.

Note that the average center-to-center distance between the two scatterers in real space is not exactly the same as d in the TS model according to equation (2). Therefore, we are going to use a new term ‘d-spacing’, which is more intuitive than d. The d-spacing hereafter represents the distance r at the first maximum of γ(r), which means the average distance to the first nearest neighbor from a scatterer, calculated using equation (2) for each fitted SAXS profile. The d-spacing can be regarded as the average center-to-center distance between two separated [PEG+EAN] domains.

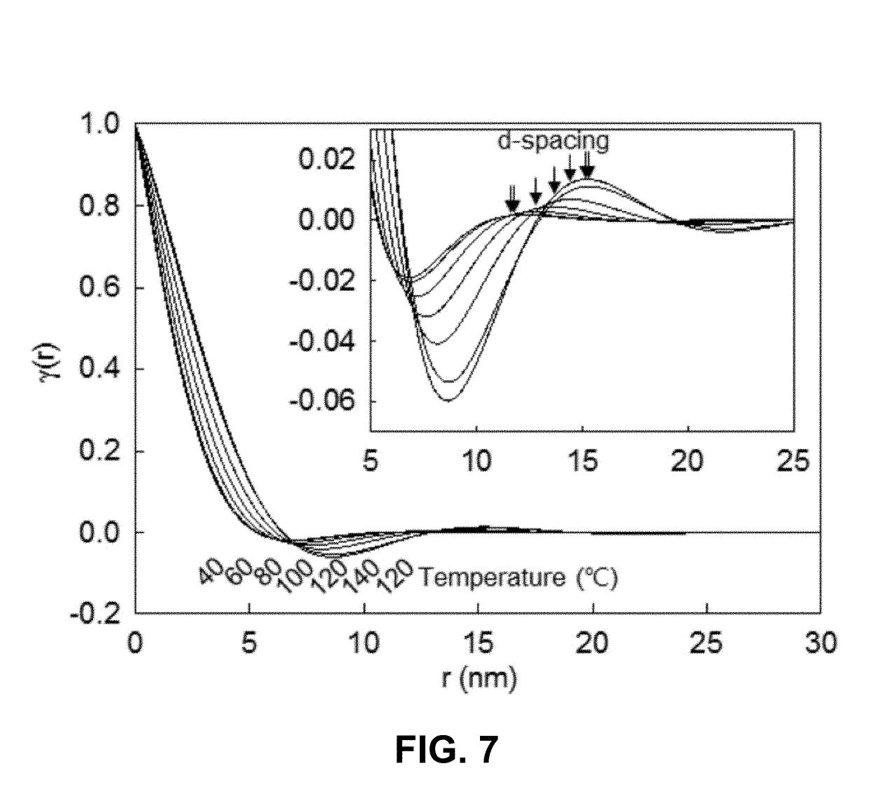

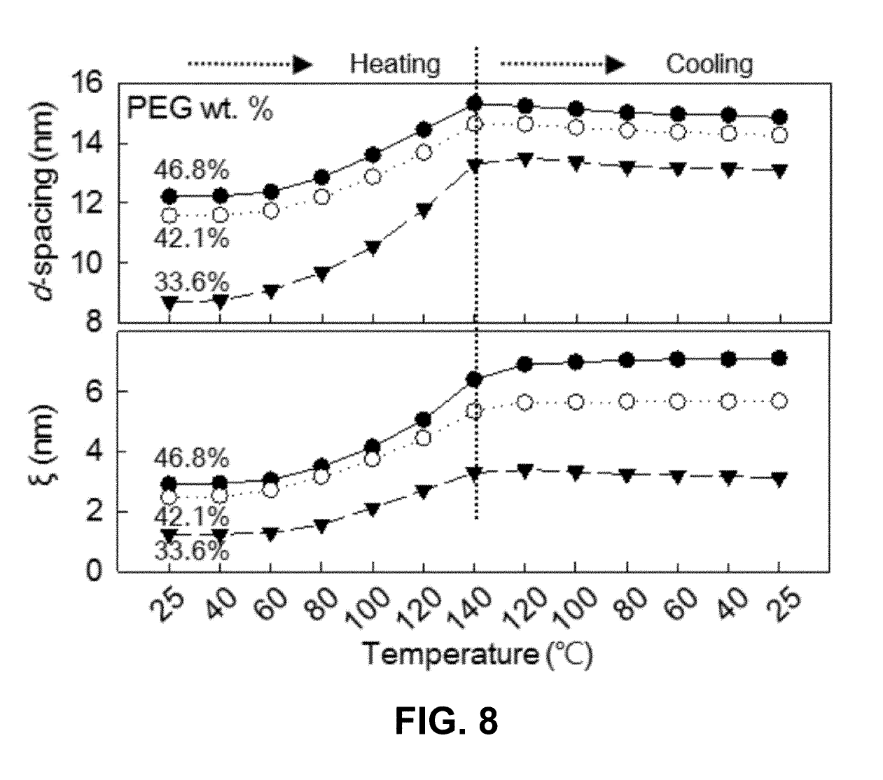

FIG. 7 shows the representative pair correlation function, γ(r), calculated using equation (2) using the best fit parameters to the SAXS profiles of the 46.8 wt % PEG-PI membrane. The d-spacing and correlation length ξ were clearly observed as increasing with the temperature. Clear rises of d-spacing and ξ with increasing temperature were also observed for the other membranes with lower PEG contents of 33.6 and 42.1 wt % as shown in FIG. 8. This means that the order in the distance between the [PEG+EAN] domains improved and the domain-domain spacing increased with increasing temperature. The maximum d-spacings were 13.3, 14.6, and 15.3 nm for the membranes with PEG contents of 33.6, 42.1, and 46.8 wt %, respectively.

Additionally, there was almost no change in d-spacing and ξ during the cooling down from 140° C. to 25° C. (d-spacings seemed to decrease slightly less than 3%) meaning that the structural change upon heating was maintained even when the membranes were cooled down to room temperature. The EAN-doped PEG-PI system seemed to be far from the equilibrium state before heating because EAN molecules penetrated into the membrane while the PI matrix network was thermodynamically fixed. The membranes possibly approached toward the equilibrium state at elevated temperatures likely due to the enhanced mobility of PI chains and the structure did not come back to the initial state upon cooling.

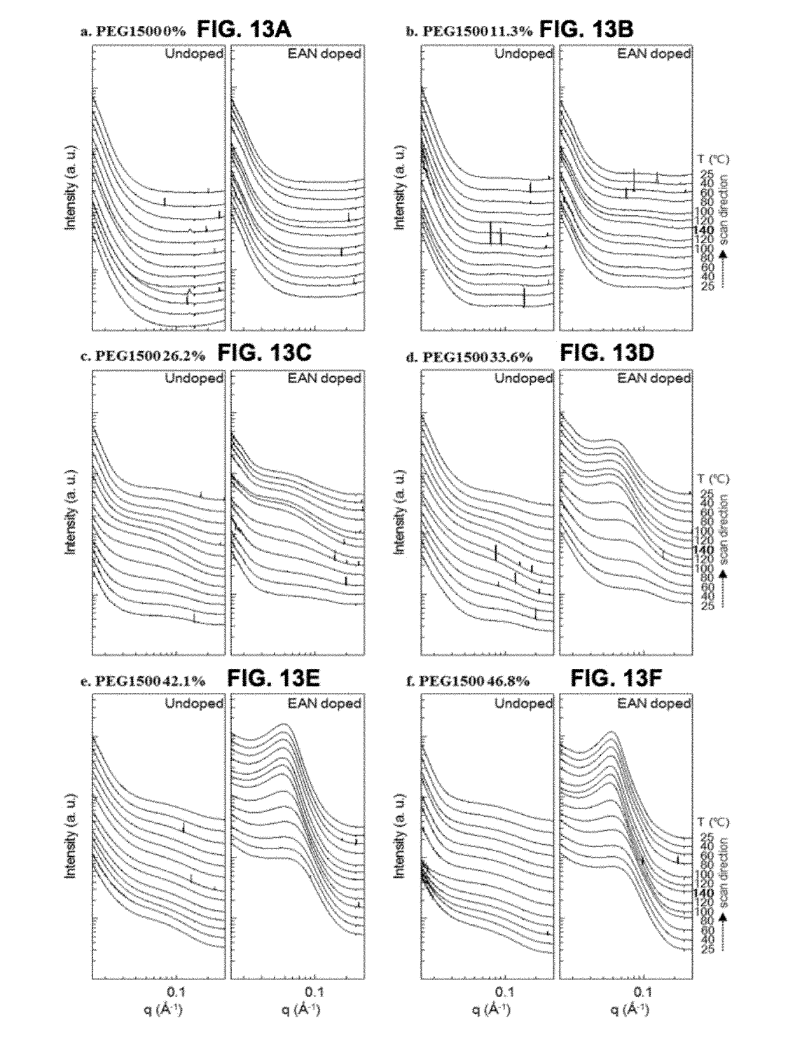

Steepening of the slope with increasing temperature was observed in the Porod regime of the SAXS profiles of EAN-doped membranes with the PEG content ranging from 33.6 to 46.8 wt % (FIG. 6 and FIG. 13). This phenomenon could be described quantitatively using the Porod analysis. The Porod exponents were determined from the slope of log I(q) vs. log q plot in the Porod regime (q-range≈0.075-0.125 Å⁻¹) as indicated in FIG. 6. The exponent (i.e. the slope in FIG. 6) decreased from −3.4 to −3.9 as the temperature increased from 25 degrees Celsius to 140 degrees Celsius for the 46.8 wt % PEG-PI membrane. Due to the small range in q values, some error could be involved in quantifying these exponent values.

If the interface is perfectly smooth, Porod's law predicts the scattering intensity at high q to be

I(q)∝q⁻⁴ (6)

Positive deviation from Porod's law (exponents >−4) can be described by the surface fractal concept. Assuming that there is rough surface or interface with a fractal dimension of dₛ between the phases, Porod's law can be modified to a generalized form:

I(q)∝q^{-(6-d}^{ₛ}⁾ (7)

Since the dₛ is between 2 and 3 for a three-dimensional surface fractal, the exponent of q is between −3 and −4. The dₛ of 2, namely the negative 4^{th} power of q, corresponds to Porod's law for a smooth surface boundary. For 46.8 wt % PEG-PI membrane, dₛ decreased from 2.6 to 2.1 as temperature increased. This indicates that the phase boundary becomes more definite or smoother as we increased the temperature of the EAN-doped PEG-PI membranes There are other approaches that can also describe the positive deviation from Porod's law including mass fractals, and electron density fluctuations within the scatterers. However, all of these approaches can be considered physically similar because they all deal with the inhomogeneity of surface or mass.

An alternative hypothesis to the structural change upon heating is the thinning of a diffuse interfacial region between [PEG+EAN] and PI phases caused by the enhanced mobility of the PI chains at elevated temperatures. However, according to the fundamental SAXS theory, the exponent is predicted to be smaller than −4 and increased to −4 if there is diffuse phase boundary that is getting thinner with increasing temperature. As our observation for the EAN-doped PEG-PI membranes is contradicting the prediction, we believe that the structural change in EAN-doped PEG-PI membranes is more related to the roughness or inhomogeneity of the interface than the thickness of the diffuse interfacial boundary.

In summary, significant nanoscale structural developments were observed upon heating of the EAN-doped PEG-PI membranes. The domain spacing and the correlation length increased with increasing temperature and the definition (smoothness) of the interface increased as well. These structural aspects were maintained even when the membranes were cooled down to room temperature.

### Conductivity Enhancement Upon Heating

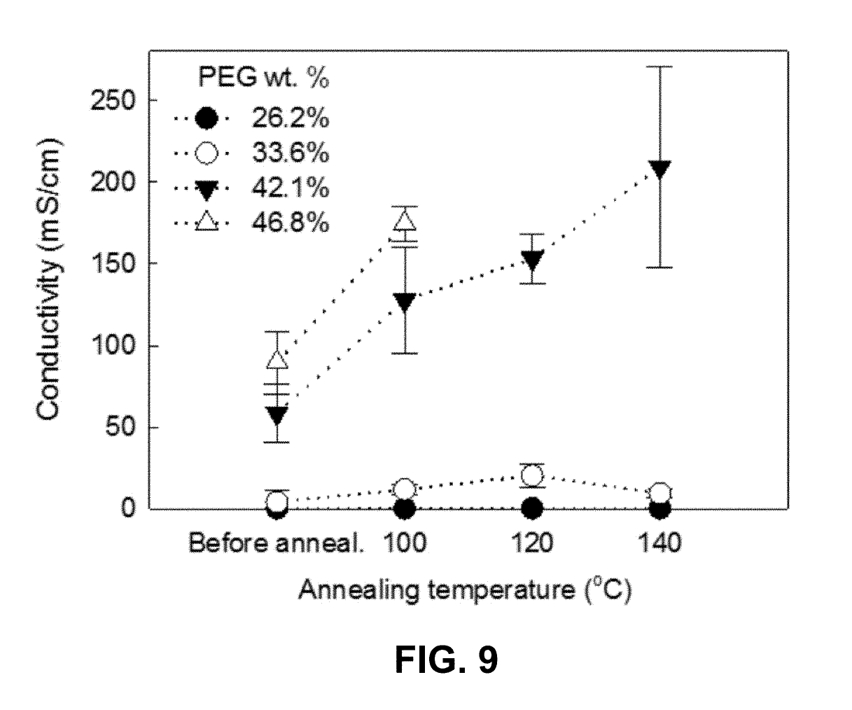

We believe that the structural development in the PEG-PI membranes at high temperatures is intimately connected to the ionic conductivity of the membrane. FIG. 9 shows the conductivity measured for the EAN-doped PEG-PI membranes depending on the annealing temperature. The conductivities of the membranes with PEG contents higher than 26.2 wt % were dramatically increased after annealing by 2-5 times than before annealing. The highest conductivity value was 209 mS/cm, which is the value averaged for 42.1 wt % PEG-PI membranes annealed at 140 degrees Celsius for 10 min. This value is more than 5 times higher than that of our Nafion measurement mentioned previously (˜39.5 mS/cm).

The conductivities of the membranes increased with increasing the annealing temperature. However, we could not anneal the membranes higher than 140 degrees Celsius because the membranes seemed to dissolve or degrade at such a high temperature, and also because the weight loss due to the EAN elimination started around 150 degrees Celsius even though the determined onset point of EAN loss in TGA were ˜180 degrees Celsius (FIG. 5).

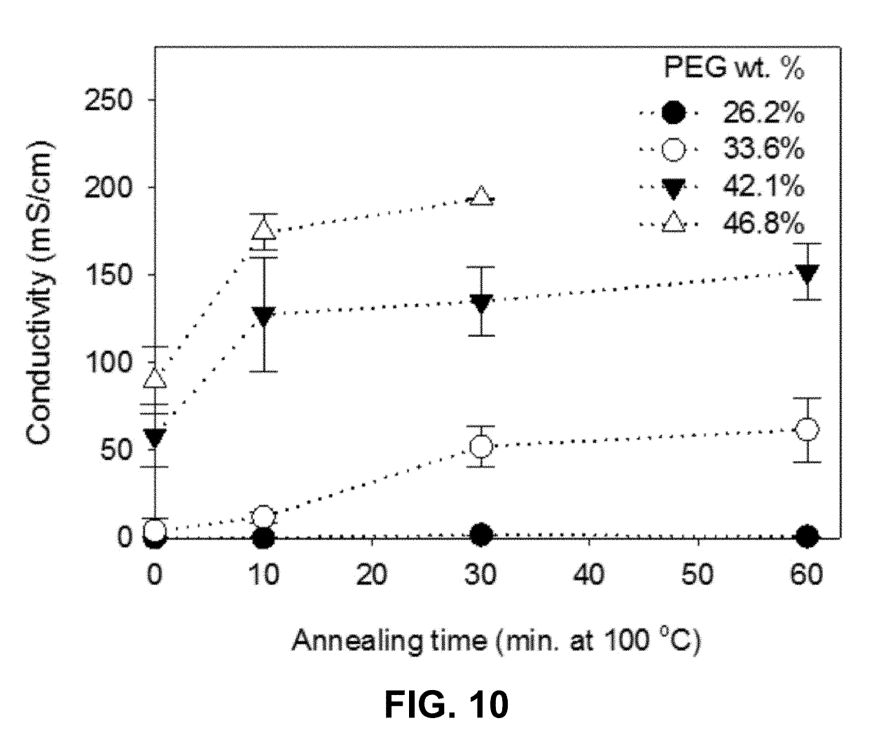

The conductivities of the membranes as a function of the annealing time was also examined and shown in FIG. 10. The conductivity of the membranes increased as the annealing time increased, but the rate of enhancement decreased as the annealing time increased. Namely, the conductivity seemed to be approaching a plateau over time.

The mechanical strength of the undoped membranes was fairly good for all PEG contents. (see Supporting Information for tensile modulus data, infra). As expected from the chemical structures of the monomers, the membrane became softer when it had higher PEG contents. The mechanical strengths of EAN-doped membranes were also good when conductivity was near 130 mS/cm or less. However, when they reached a conductivity higher than 150 mS/cm, they were very soft and easily torn. The optimal membrane with a balanced conductivity and mechanical strength may be the one with the conductivity of 100-130 mS/cm and the PEG contents of 30-40 wt %.

### Supporting Information

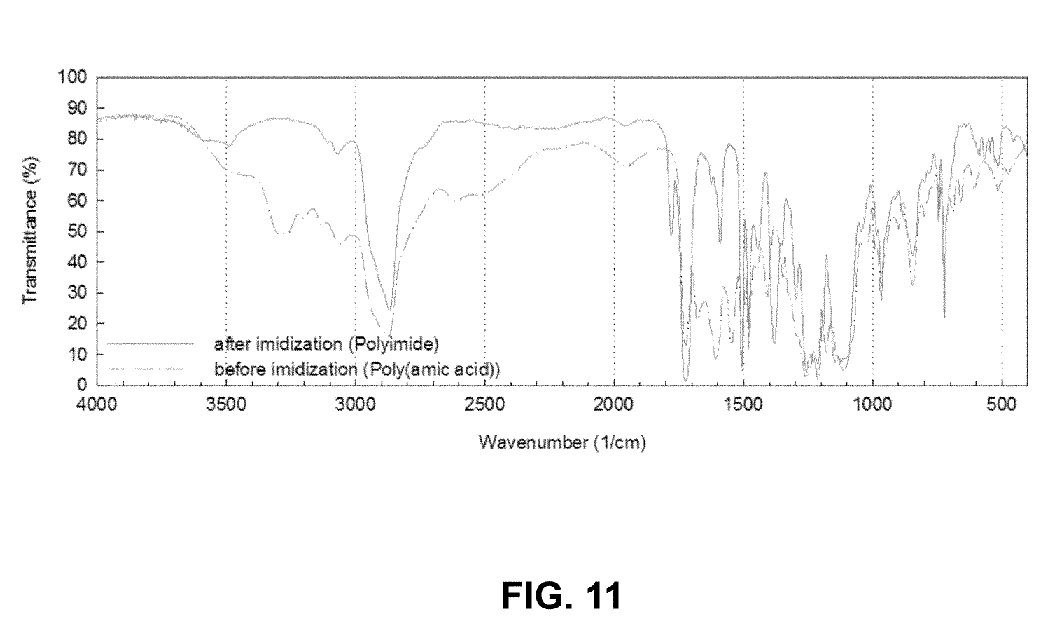

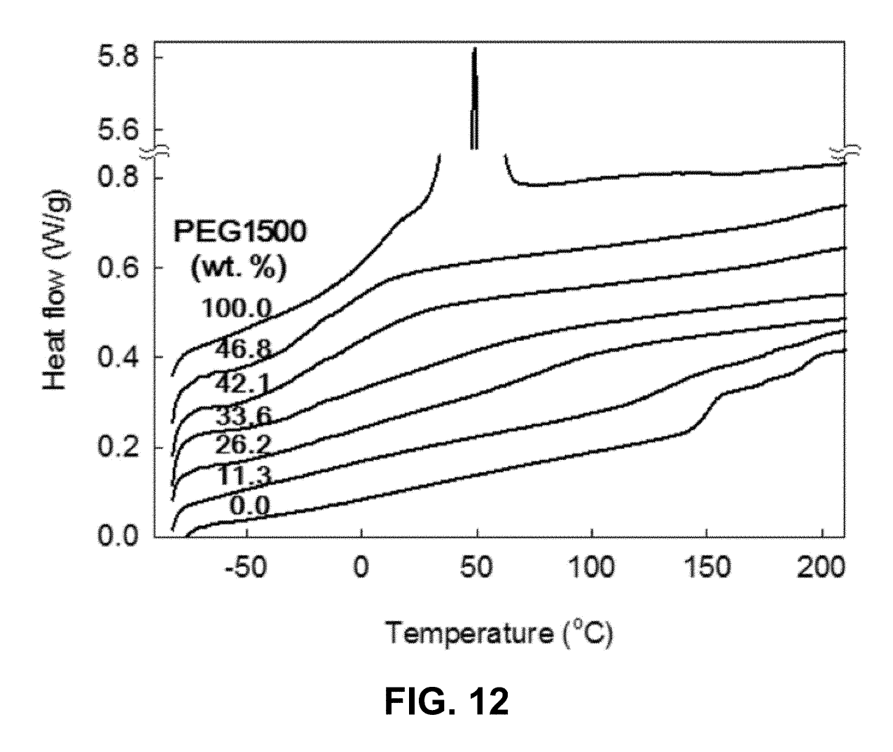

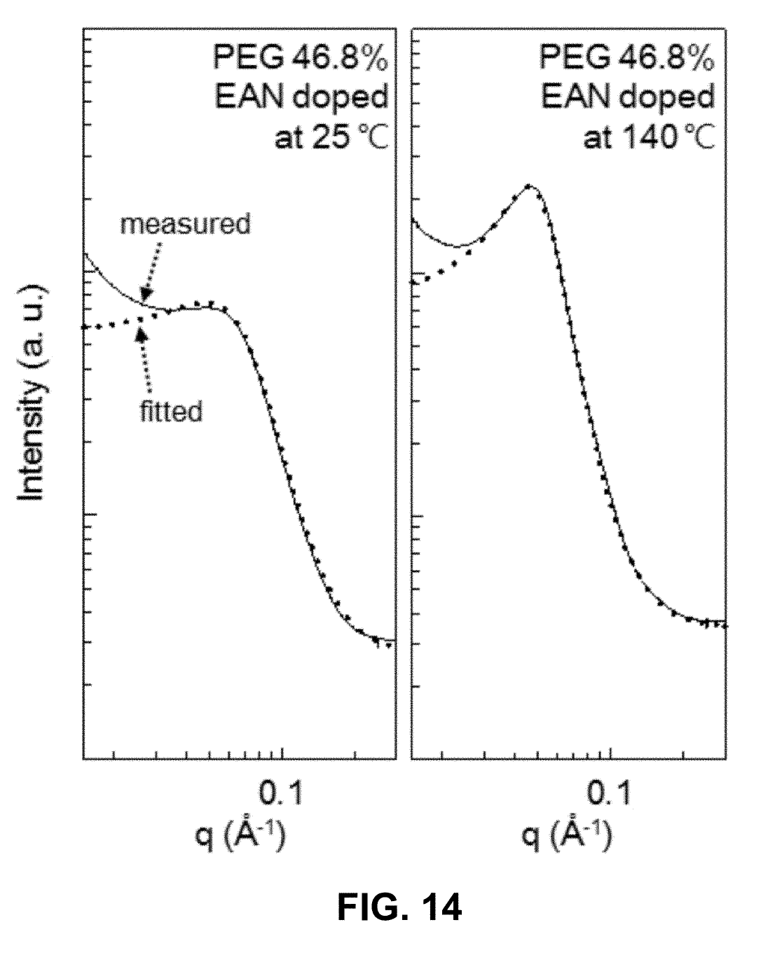

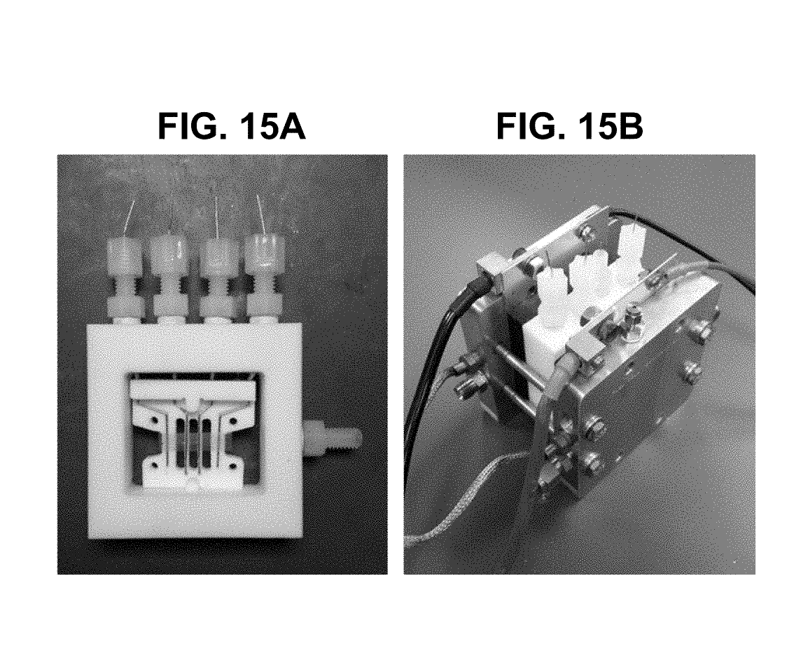

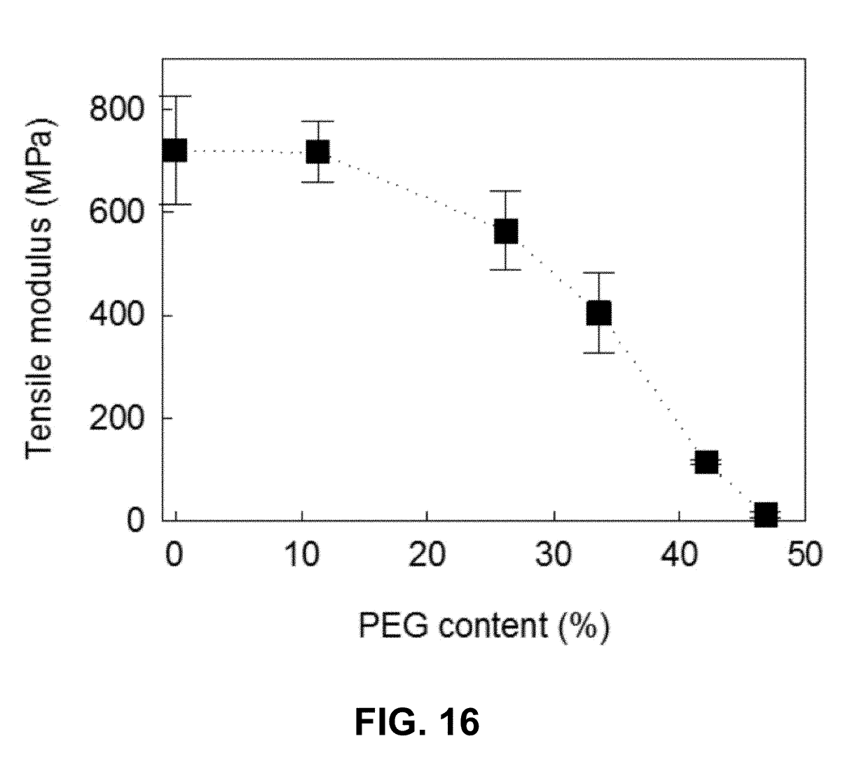

The success of the synthesis of poly(amic acid) and the thermal imidization were confirmed using FTIR. The FTIR spectra of the polyimides include peaks indicating imidization. There was also a reduction in the features corresponding to the poly(amic acid). A specific example of these observations can be seen in the spectra of PEG 46.8% poly(amic acid) and polyimide, in FIG. 11. New, clear absorption bands appeared around 1728, 1778, 1396, and 723 cm⁻¹, and the other absorption bands in the range of around 1535˜1666 and 2880˜3440 cm⁻¹ disappeared in the example provided. Supporting figures are: FIG. 11 which shows FTIR spectra of PEG 46.8 wt % poly(amic acid) and polyimide. FIG. 12 which shows DSC thermograms of PEG-PI membranes with various PEG content. FIGS. 13A-F which show SAXS profiles of PEG-PI copolymer membrane with different PEG contents. FIG. 14 which shows SAXS profiles of PEG-PI copolymer membrane with 46.8 wt % and fitted functions using the Teubner-Strey model. Dotted lines are the fitted functions using the Teubner-Strey (TS) model, which showed the best fit to the SAXS data among several theoretical or empirical models describing the SAXS intensity including the Guinier-Porod model, the correlation length model, and the broad peak model. The data below q=0.035 Å⁻¹ were ignored in the fitting because there was assumed to be a large error in the averaged intensity near the beam center even though the background signal was correctly subtracted. FIGS. 15A-B which show pictures of (FIG. 15A) the conductivity clamp with a PEG-PI membrane and (FIG. 15B) the conductivity cell used in this invention. FIG. 16 which shows tensile modulus (TM) of undoped PEG-PI membranes. TM of PEG-PI membranes decreased with increasing the PEG content. TM of Nafion N115 membranes were ˜250 and ˜180 MPa for undoped and water doped membranes respectively.

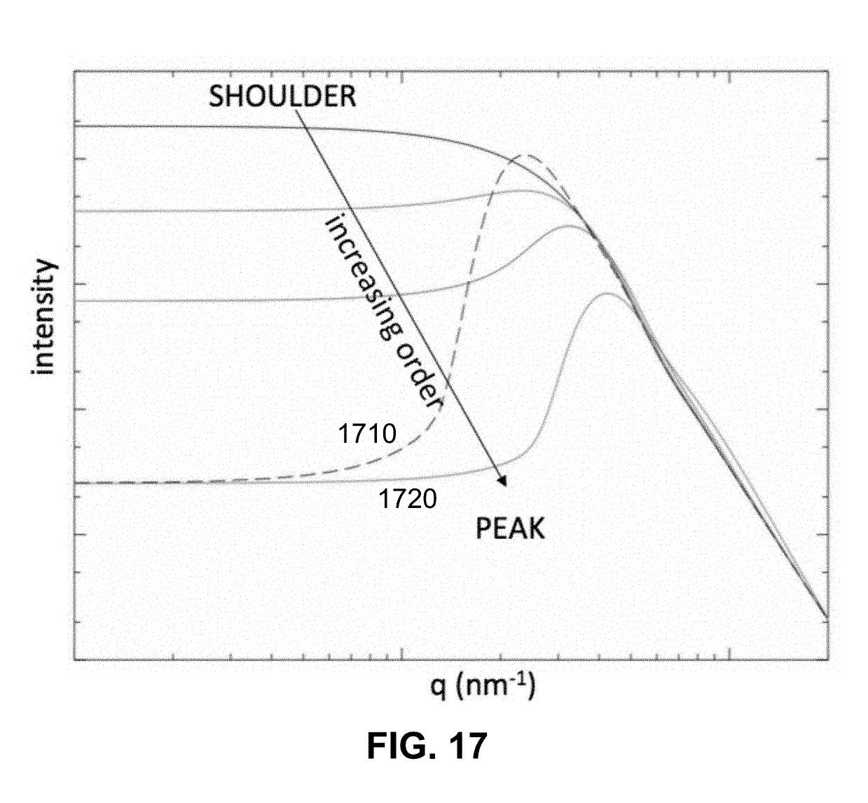

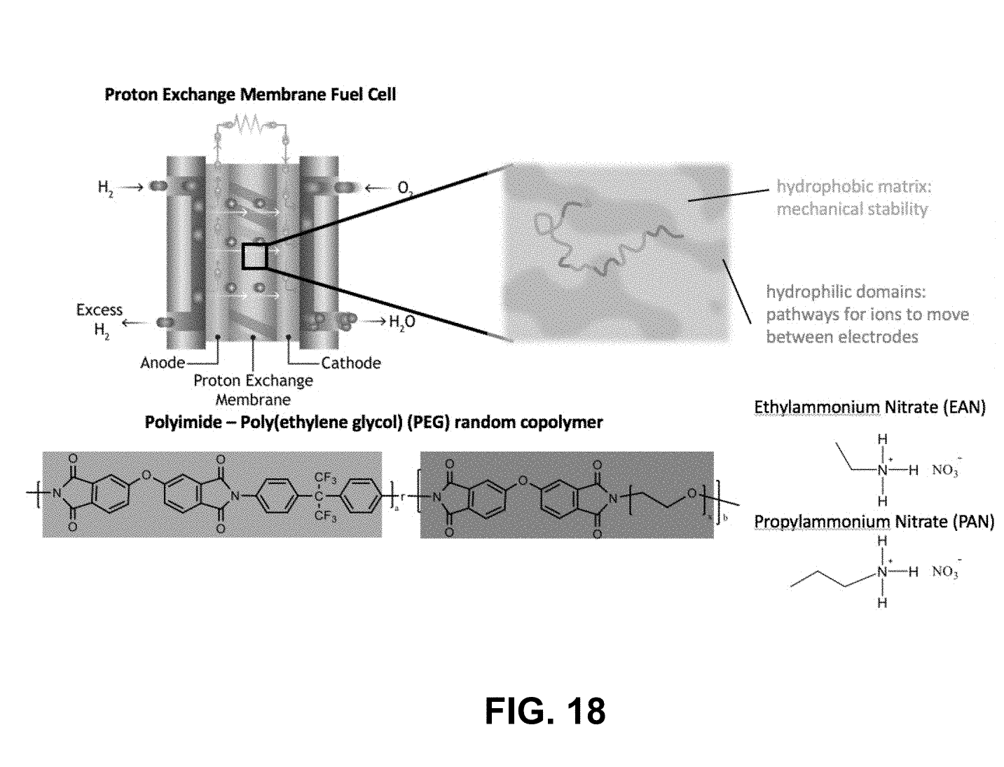

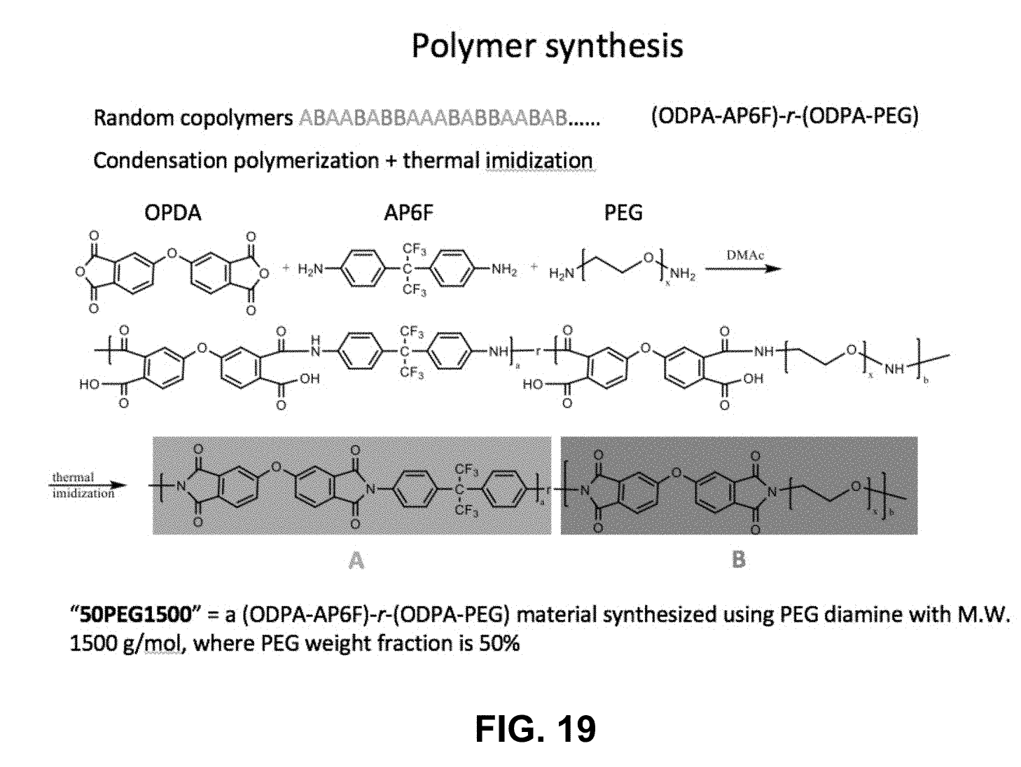

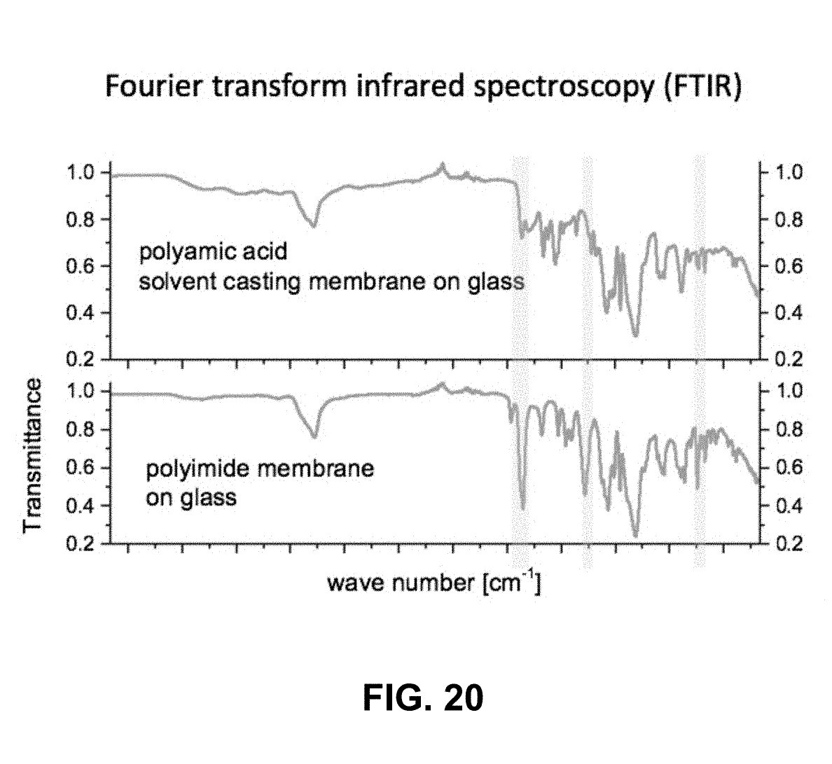

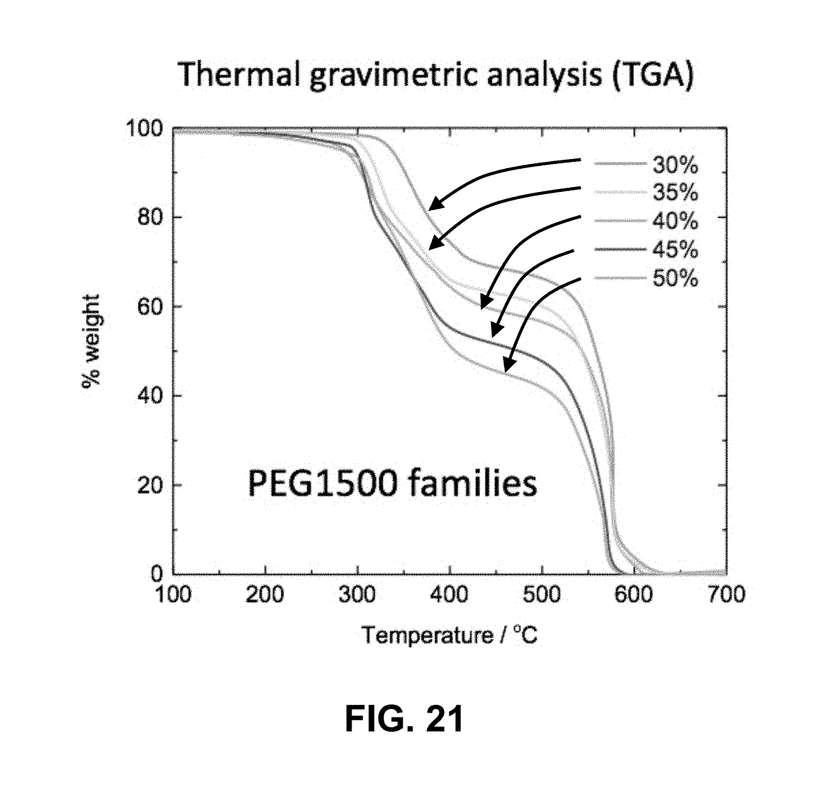

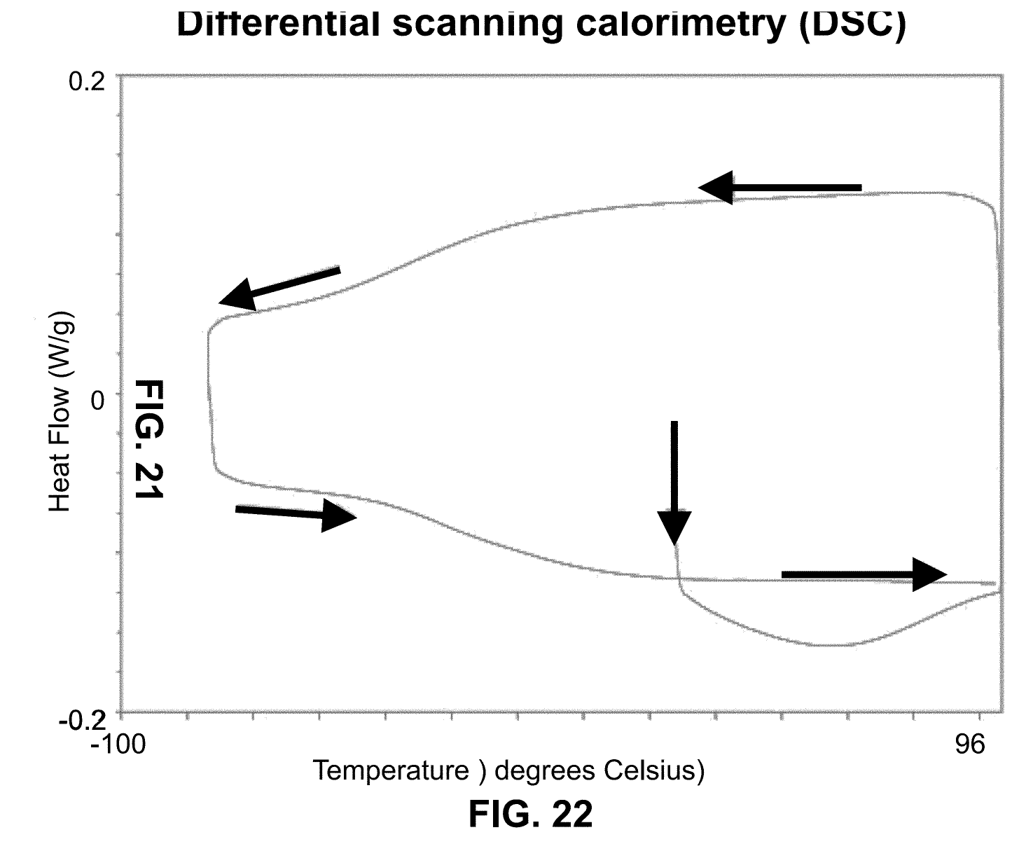

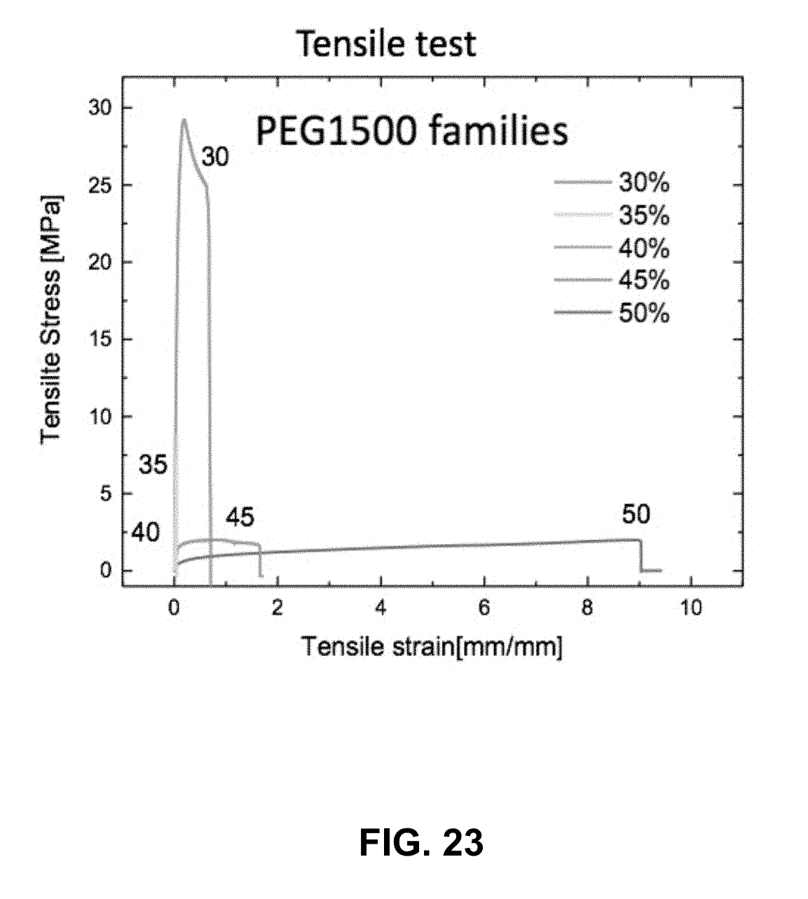

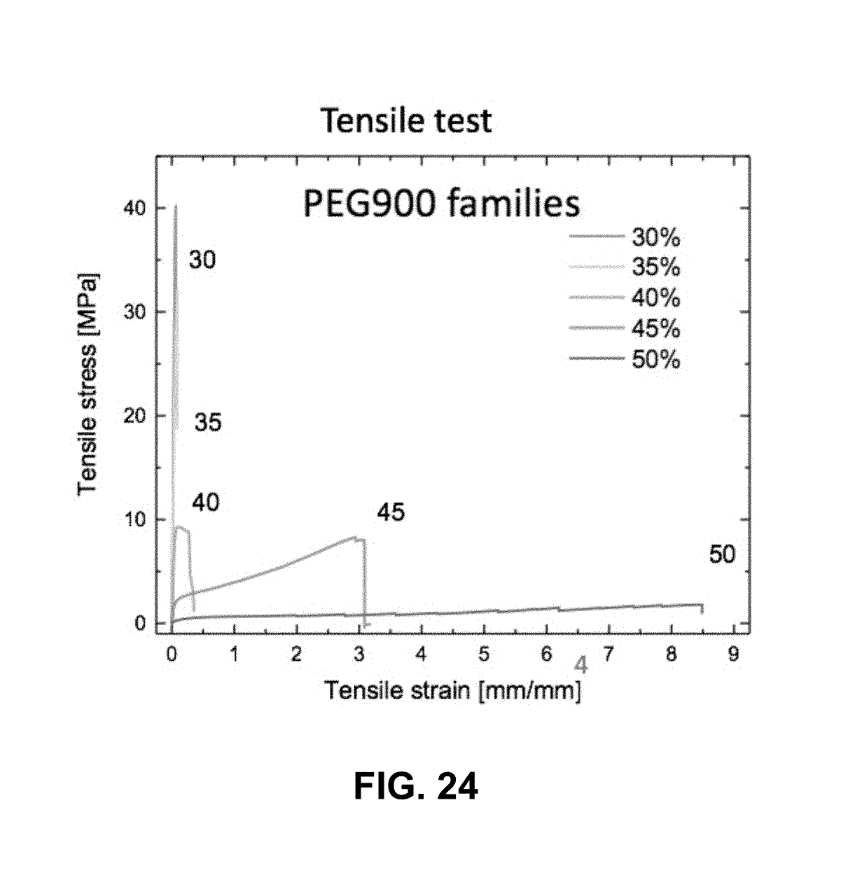

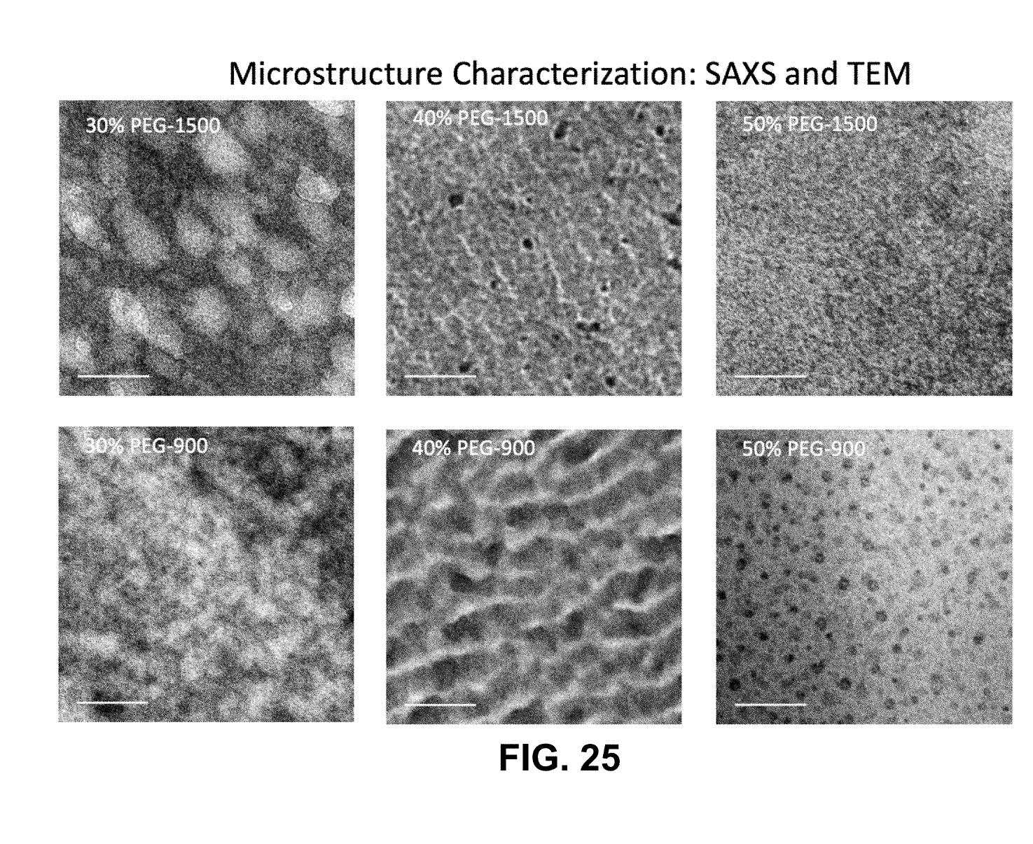

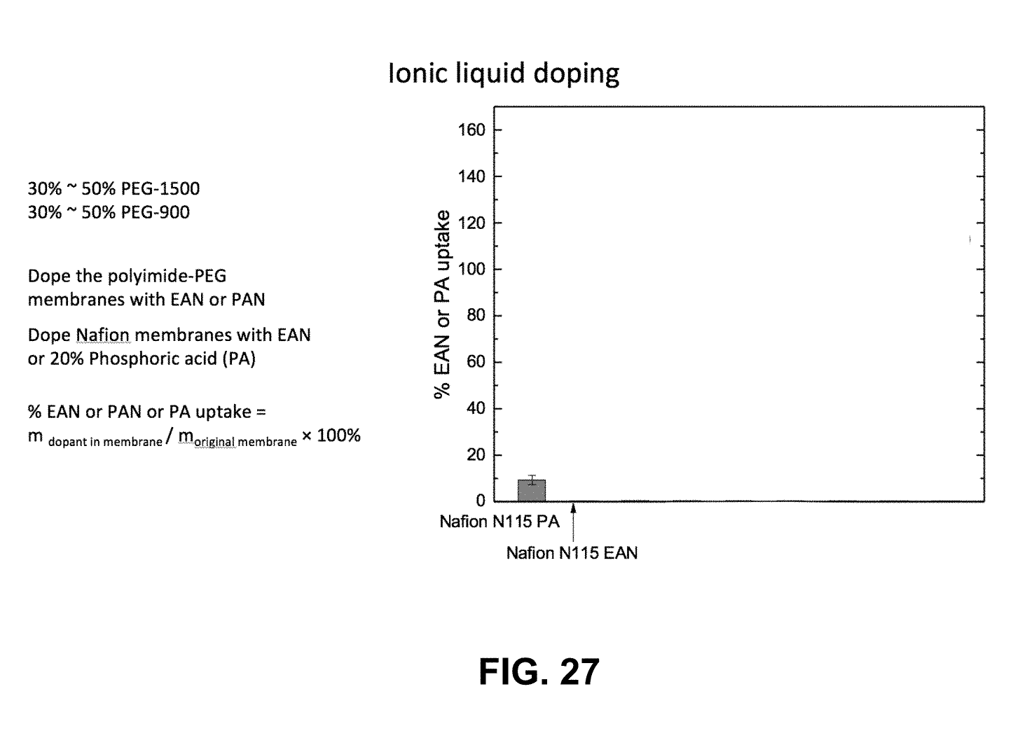

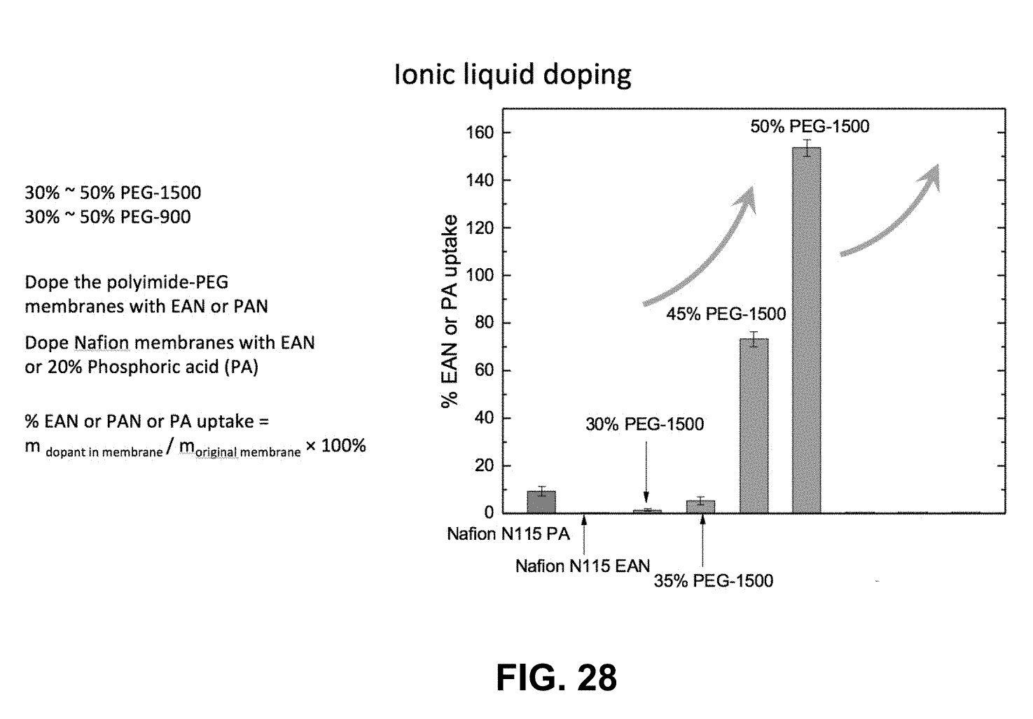

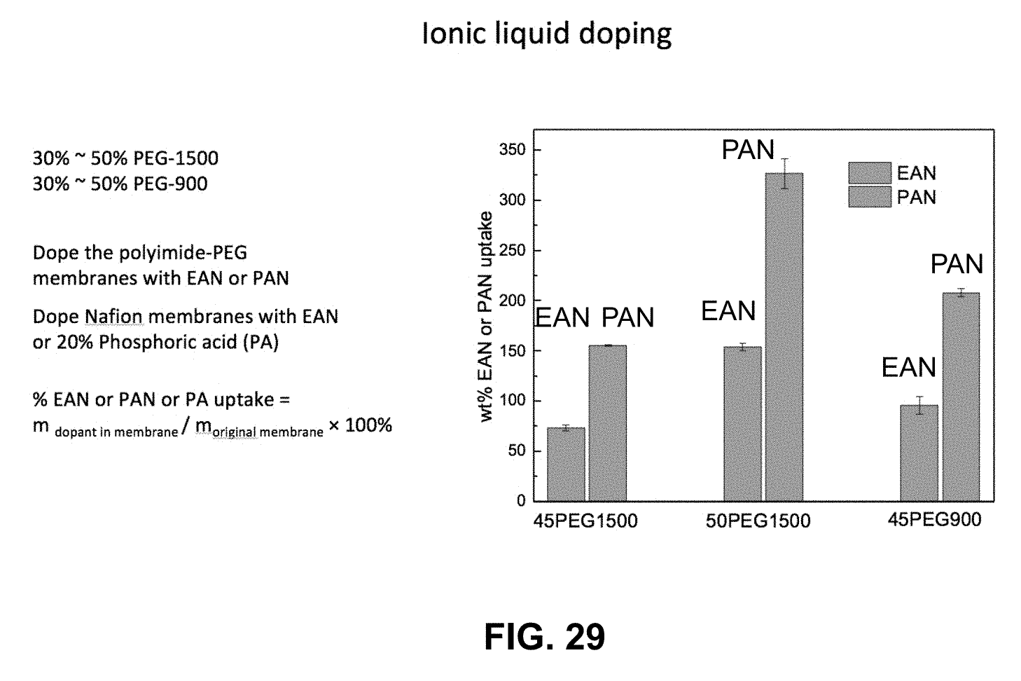

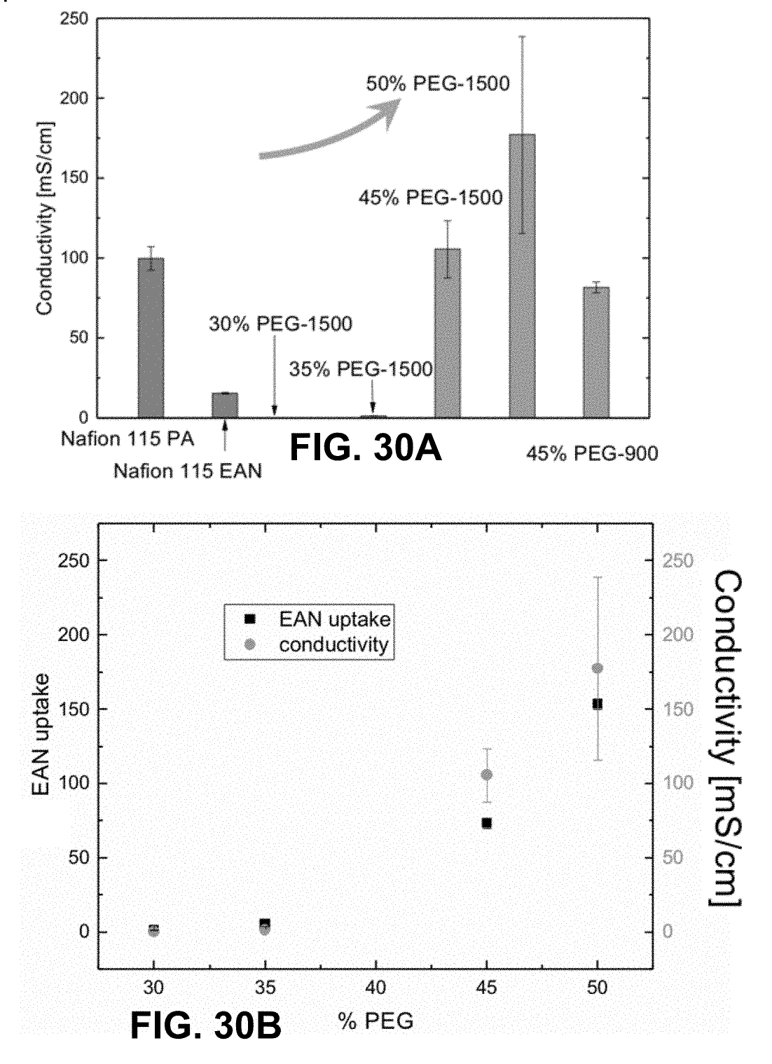

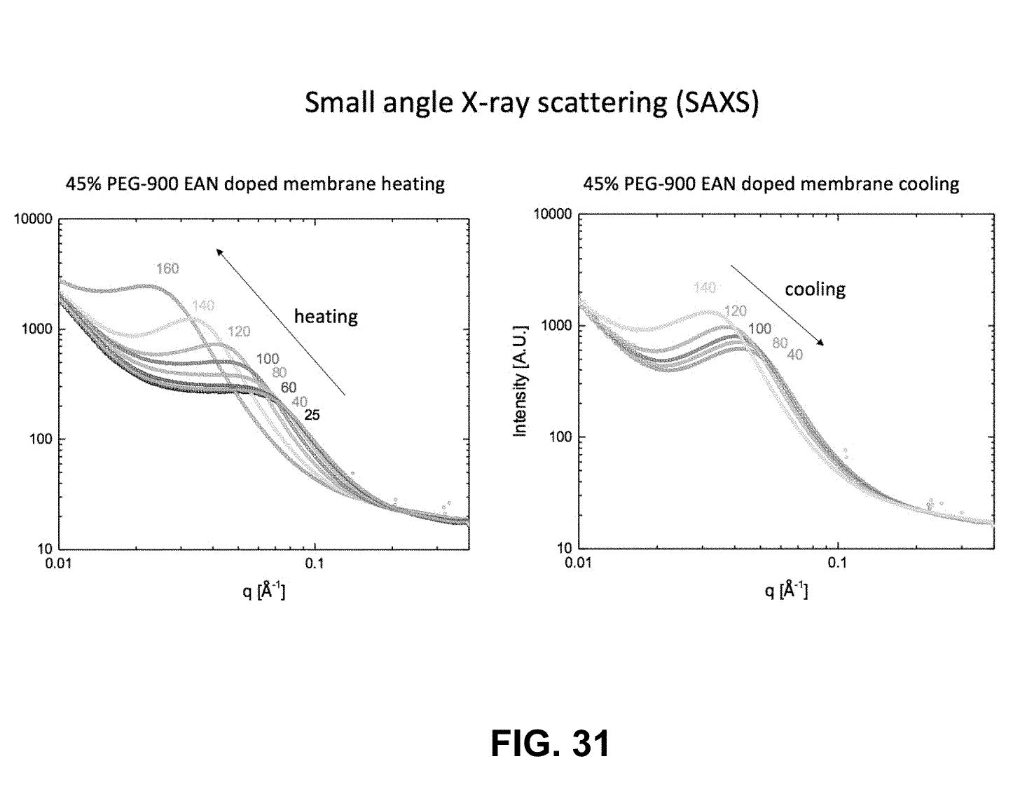

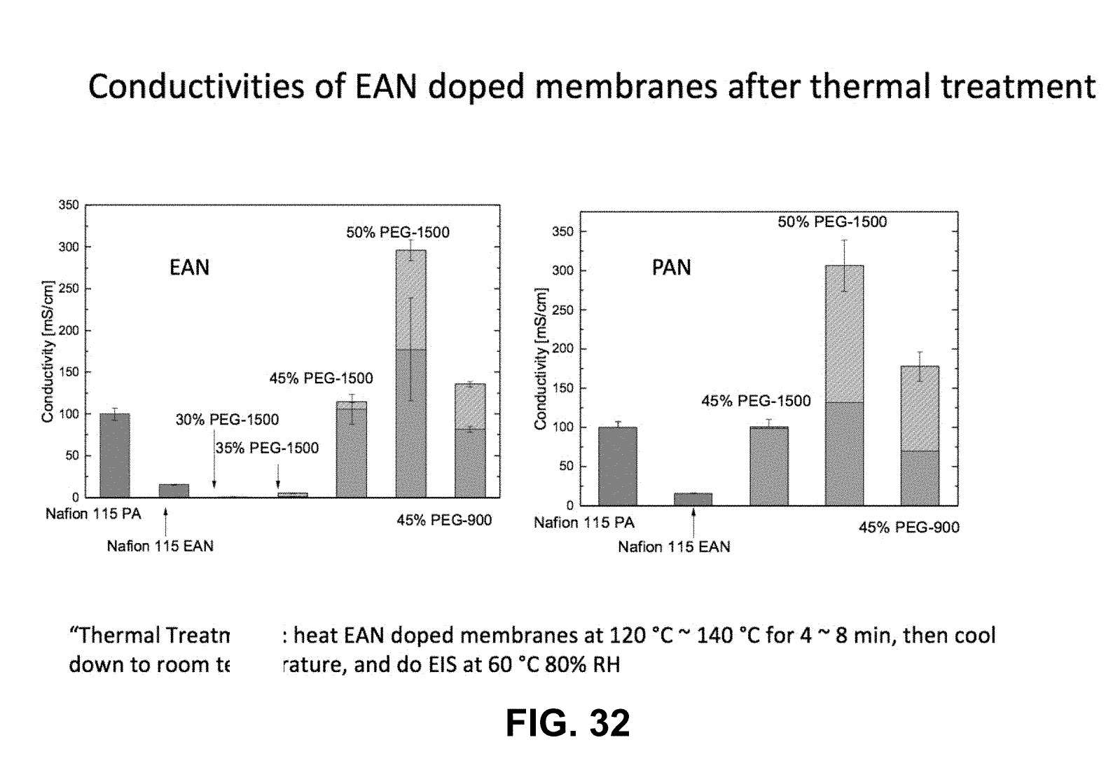

### Additional Notes (FIGS. 17-32)

The primary manifestation of the nanostructure of our highly conducting material is the existence of a distinct peak in the small angle scattering pattern. For PEG concentrations of 30% or less, this region of so-called “q values” in the scattering space only exhibits a broad shoulder. Beginning with PEG concentration of around 40%, a distinct scattering peak appears, which grows with increasing PEG concentration. This distinct peak means that there is a structural correlation among component elements of the polyimide-PEG random block copolymer. This correlation could indicate the existence of PEG domains that are above the percolation threshold for ion transport or the existence of channels having a preponderance of PEG content surrounded by the aromatic polyimide matrix. In either case, it is the nanostructured nature of the material that provides the invention. The existence of this peak is correlated with the uptake of the ethyl ammonium nitrate (EAN) ionic liquid, which is directly correlated with the increase in conductivity.

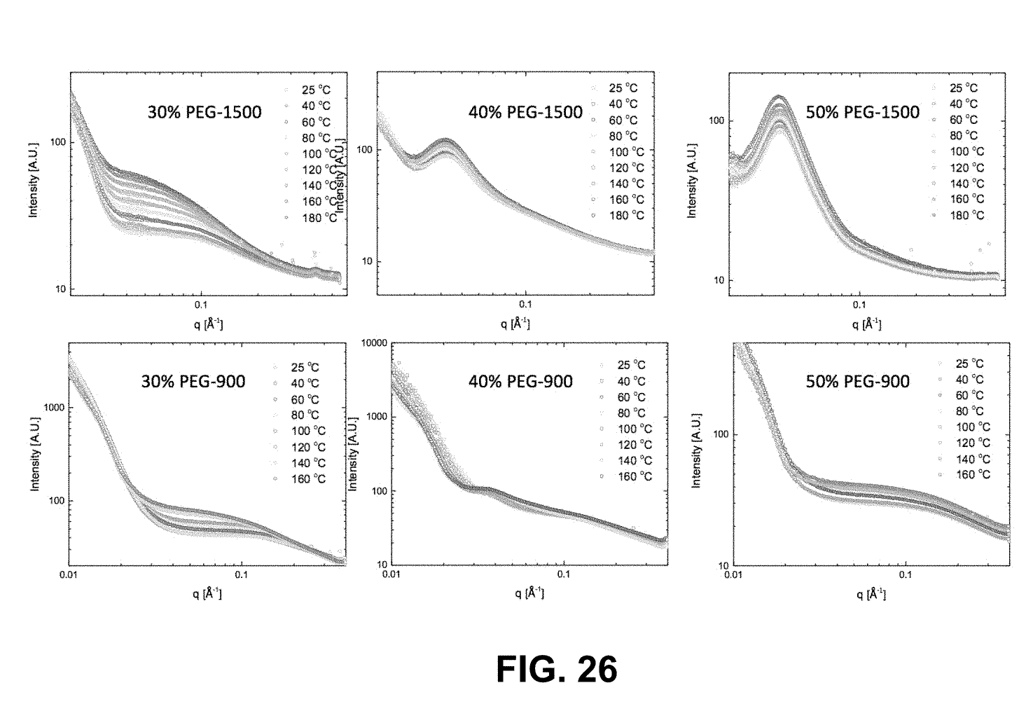

A peak in the small angle x-ray scattering (SAXS) plot of the logarithm of the intensity versus the logarithm of the wave vector q is considered to be a feature of the scattering curve that exhibits a clear maximum intensity with at least a 20% drop in intensity as the curve extends to lower q values. For example, the scattering data shown for 45% and 50% PEG content in FIG. 26 indicate that the scattering peak maximum is at approximately 0.04 reciprocal Angstroms. In fact, the scattering curve drops considerably more than 20% of the maximum as q decreases in these two examples, but a drop of 20% is within the range that is easily detected experimentally; thus, it is a reasonable structural characterization parameter. The greater the decrease in peak intensity in this “valley”, the sharper the peak and the higher the degree of structural order. The peak position can be related to the size scale of the nano-structured features, and a change in this peak position with thermal annealing indicates that the nanostructure is changing. A shift of the peak maximum to lower q means that the characteristic dimension of the nano-structured features is increasing.

### Abbreviations

6FDA, 4,4′-(hexafluoroisopropylidene) diphthalic anhydride.
PDODA, 4,4′-(1,3-phenylenedioxy)dianiline.
PEG1500, bis(3-aminopropyl) terminated poly(ethylene glycol).
DMAc, N,N-dimethylacetamide; EAN, Ethylammonium nitrate.

What is claimed is:

1. An ion exchange membrane, comprising a nanostructure material of random poly(ethylene glycol)-polyimide copolymers doped and annealed in an ionic liquid, the poly(ethylene glycol) having a molecular weight ranging from 1000 to 4000 and the poly(ethylene glycol) representing at least 40% of the volume of the ion exchange membrane.

2. The ion exchange membrane as set forth in claim 1, wherein the poly(ethylene glycol) has a molecular weight of 1000 to 2500.

3. The ion exchange membrane as set forth in claim 1, wherein the poly(ethylene glycol) has a molecular weight of about 1500.
